(19) United States
(12) Patent Application Publication
(10) Pub. No.: US 2005/0084616 A1
(43) Pub. Date: Apr. 21, 2005

(54) Method and composition for treating metal surfaces using a polymer blend and an organo-functional silane

(76) Inventors: Jose B. Rivera, Philadelphia, PA (US); Norman H. Schellenger JR., Lansdale, PA (US)

Correspondence Address: RATNERPRESTIA, P O BOX 980, VALLEY FORGE, PA, 19482-0980, US

(21) Appl. No.: 10/690,349

(22) Filed: Oct. 21, 2003

(51) Int. Cl. C08L 1/00

(52) U.S. Cl. 427/331; 524/522; 524/524; 524/262

(57) ABSTRACT

A method and composition for treating metal surfaces improves the paint adhesion of the metal surface, particularly its resistance to delamination of paint over a stressed area in the finished metal upon exposure to hot water. The composition is an aqueous composition of an organo-functional silane, a compound of a group IV-B element, and a polymer blend having a plurality of carboxylic functional groups and a plurality of hydroxyl groups. The method includes contacting a metal surface, such as aluminum, with the composition. The polymer blend is preferably a mixture of polymethylvinylether-co-maleic acid and polyvinyl alcohol. The organo-functional silane is preferably an epoxy silane.

### FIELD OF THE INVENTION

This invention relates to improving the corrosion resistance and paint adhesion of metal surfaces, particularly the ability of a finished metal to resist delamination of a stressed area subjected to hot water.

### BACKGROUND OF THE INVENTION

Known methods of treating metal surfaces to improve paint adhesion and corrosion resistance of the painted metal surfaces can be categorized into two general classes of chemistries. The first class is based on traditional conversion coating types of chemistries, such as zinc phosphate, iron phosphates, chromium chromate, chromium phosphate, etc. The second class is based on more recent developments in the metal pretreatment industry and is characterized by what is now referred to as dried-in-place technology. Traditional conversion coating chemistries require rinsing of the metal substrate to remove applied pretreatment solution. Dried-in-place chemistries allow for the applied solutions to be dried on the metal substrate to which they are applied, without subsequent rinsing.

Chromium compounds have been used as traditional conversion coatings to treat metal surfaces. Such chromium compounds show toxicological effects and have been determined by the Environmental Protection Agency to be a risk to the environment and by the Occupational Safety and Health Agency to be a health risk. Moreover, hexavalent chromium compounds such as are used in some of these systems are classified as carcinogens by these agencies.

Much effort has been expended in developing compositions and methods for producing chromium-free pretreatements. For example, the owner of the present application has commercialized products that are successful in improving the corrosion resistance and paint adhesion of metal surfaces. Such compositions are disclosed in, for example, U.S. Pat. No. 5,859,106 to Jones et al, directed to an aqueous composition including a polymer system having carboxylic functional groups and hydroxyl groups and a compound of a group IV-B element.

An extrusion process is an operation in which a material is forced through a metal forming die, followed by cooling or chemical hardening. In coil coating, a roll of metal is unwound, sequentially and continuously cleaned, treated and decorated (i.e., painted and baked). Painted stock is rewrapped and then used to create articles. Articles formed from this prepainted coil obviously do not require further painting and baking. Thus, a convenient and economic means for producing articles is achieved.

Because the prepainted coil must be cut, bent, impacted, and shaped into a desired article, the adhesion of the paint to the metal surface is important. One measure of the paint adhesion is the Post Opening test referred to above. Further, corrosion resistance can be of importance since an article produced from painted coil can be required to perform in severe weather. Articles such as siding and rainwear (e.g., gutters and spouts) are some examples.

There remains a need for compositions and methods for improving paint adhesion and corrosion resistance of metal surfaces, such as aluminum, especially with respect to the ability of a finished metal to resist paint delamination from a stressed substrate area subjected to hot water. The test procedure measuring this characteristic is referred to as a “Post Opening” test. In this test, the finished metal (i.e., a metal sample that has been cleaned, pretreated, and painted) to be tested is bent back over itself to produce the familiar T-bend. The painted metal is then laid faced down and impacted from behind to produce a dimple that stretches the paint outwardly. The dimpled sample is then place in boiling water for two minutes. If the sample shows, at worst, cracking of the paint on the dimple or T-bend, it passes the test. However, if the paint on the dimple or T-bend pulls back and delaminates excessively, it is a failure. Such testing is commonly performed according to Technical Bulletin 4.3.6, issued June, 1996 by the National Coil Coaters Association. In situations where the paint is an acrylic paint, it is desirable for the pretreatment to assist the metal to pass this test when the metal has been painted with this type of paint.

### SUMMARY OF THE INVENTION

In one aspect, the invention is a composition for treating a metal surface to improve paint adhesion and corrosion resistance. The composition comprises water, an organo-functional silane, a compound of a group IV-B element, and a polymer blend having a plurality of carboxylic functional groups and a plurality of hydroxyl groups.

In another aspect, the invention is a composition for treating a metal surface to improve paint adhesion and corrosion resistance. The composition consists essentially of water, an organo-functional silane, a compound of a group IV-B element, and a polymer blend having a plurality of carboxylic functional groups and a plurality of hydroxyl groups.

In yet another aspect, the invention is a method for treating a metal surface to improve paint adhesion and corrosion resistance comprising contacting the metal surface with a composition comprising water, an organo-functional silane, a compound of a group IV-B element, and a polymer blend having a plurality of carboxylic functional groups and a plurality of hydroxyl groups.

In still another aspect, the invention is a method for treating a metal surface to improve paint adhesion and corrosion resistance comprising the steps of:
cleaning the metal surface to form a cleaned metal;
rinsing the cleaned metal with water to form a rinsed metal; and
contacting the rinsed metal with a composition comprising water, an organo-functional silane, a compound of a group IV-B element, and a polymer blend having a plurality of carboxylic functional groups and a plurality of hydroxyl groups.

### DETAILED DESCRIPTION OF THE INVENTION

The present invention is directed to chromium-free compositions and methods for treating metal surfaces to improve paint adhesion and corrosion resistance. Compositions according to the present invention comprise water, an organo-functional silane, a compound of a group IV-B element, and a polymer blend having a plurality of carboxylic functional groups and a plurality of hydroxyl groups. It has been discovered that such compositions improve adhesion of decorative coatings such as paint while maintaining good corrosion resistance properties in certain systems. For example, one composition according to the present invention overcomes a particular problem pertaining to a commercial acrylic coil paint, sold by PPG under the trademark Duracron™ 1000 Polar White Paint, when used on aluminum coil. This thermosetting acrylic paint comprises titanium dioxide, normal butyl alcohol, xylene, heavy aromatic solvent naphtha, diacetone alcohol, a ketone mixture, light aromatic solvent naphtha, one or more film formers, and one or more resins. The problem manifests itself as a delamination of paint over a stressed area in the finished metal when exposed to hot water (i.e., failure of the Post Opening test).

As used herein, the term “pretreatment composition” means any composition which improves the paint adhesion and corrosion resistance of a metal surface. The term “chromium-free coating composition” means a pretreatment composition which does not include chromium in any form.

As used herein, the term “metal,” used for example in the phrase “metal surface,” includes aluminum, iron, zinc, and combinations thereof. Each metal listed includes both the elemental metal and alloys thereof; for example, the term “aluminum” means aluminum and aluminum alloys, with an aluminum alloy being a metal in which aluminum is present in an amount at least equal to that of any other element. Iron alloys include cold rolled steel, electro-galvanized steel, and hot-dipped galvanized steel.

As used herein, the term “silane” has the same meaning as defined in U.S. Pat. No. 5,393,353 to Bishop, which is incorporated herein by reference. In addition, the term “organo-functional silane” has the same meaning as defined in U.S. Pat. No. 6,126,997 to Rivera et al., also incorporated herein by reference. Specifically, the term “organo-functional silane” means a silane which includes an organic group (such as an alkyl, an aryl or an alkoxy group) and a functional group which serves to bond with or assist in bonding with polymers in the pretreatment or paint. Such functional groups include, but are not limited to, amino, epoxy, vinyl and mercapto groups. Exemplary organo-functional silanes which can be used according to the present invention include aminopropyltriethoxy silanes, mercapto silanes, and epoxy silanes. Among a variety of silane compounds which will function within the scope of this invention are aminopropyltriethoxy silane, sold under various trade names such as AMEO from Degussa A G of Dusseldorf, Germany, Silwet® A-1100 from Crompton Corporation of Greenwich, Conn., and an epoxy functional silane sold by Degussa under the trade name of Hydrosil® 2759.

As used herein, the term “group IV-B compound” mean an acid and/or a salt of a group IV-B element, as described in U.S. Pat. No. 5,859,106 to Jones et al., incorporated herein by reference. Such acids include fluozirconic acid (H₂ZrF₆), fluotitanic acid (H₂TiF₆), and fluohafnic acid (H₂HfF₆). An exemplary salt of a Group IV-B element is ammonium zirconium carbonate. An ammonium zirconium carbonate solution sold by Magnesium Elektron Inc. of Flemington, N.J. under the trademark Bacote®20, having a working empirical formula of (NH₄)₂[Zr(OH)₂(CO₃)₂.nH₂O, may be used according to the present invention. Without wishing to be bound by any particular theory or explanation, it appears that the group IV-B element, such as zirconium, increases the interaction between the composition and the metal surface, in effect helping to bond the composition to the metal surface.

As used herein, the term “treating” shall mean applying a pretreatment, or cleaning and applying a pretreatment, and optionally can also include process steps up through painting. Each of these steps—cleaning, pretreating, and painting—plays a role in a painted product's ability to resist corrosion and minimize paint loss.

The compositions of the present invention also contain a polymer blend having a plurality of carboxylic functional groups and a plurality of hydroxyl groups. The polymer blend may be a mixture of a first polymer having carboxylic functional groups (—COOH) and a second polymer having hydroxyl groups (—OH). In this embodiment, the first polymer may be, for example, polyacrylic acid or polymethylvinylether-co-maleic acid, and the second polymer may be polyvinyl alcohol. As is well-known and described in the '106 patent, carboxylic functional groups and hydroxyl groups tend to undergo an esterification reaction under certain conditions. Thus, the term “polymer blend” encompasses blends where little or no ester formation occurs, and blends where some appreciable amount of such a reaction occurs.

Typically, polymer blends for use according to the invention are made by simply mixing at room temperature the first and second polymers, for example polyvinyl alcohol (PVA) and polymethylvinylether-co-maleic acid (PMVEMA), with water at a ratio of carboxylic acid to hydroxyl equivalents of about 1.0 to achieve a concentration of about 2.1 wt. %. This method of preparing a polymer blend suitable for use in this invention is well known in the art, and is described for example in the '106 patent. Using this method of preparation, even if there is some degree of ester formation, not all of the carboxylic acid functional groups and the hydroxyl groups react to serve to cross-link the polymer chains and form water. Thus, many (or even all or substantially all) of the carboxylic groups and hydroxyl groups remain free on the polymeric chains. It has been found that polymer reactants of slightly higher molecular weight are preferred for a coil coating application than those for an extrusion process.

The amount of the first and second polymers utilized, and the relative concentrations of the reactants which form the polymeric blend, can vary over a wide range. The operable ratio of the first polymer to the second polymer can be expressed as the ratio of carboxylic functional groups of the first polymer to hydroxyl groups of the second polymer. The range of acceptable ratios of carboxylic acid to hydroxyl functional group equivalents is between 0.3:1 and 3.5:1.

In addition, the ratio of silane to the total of first and second polymers may be no lower than about 0.3, preferably no lower than about 0.5. The ratio may be no higher than about 2.0, preferably no higher than about 2.0.

The amount of polymeric material present in the solution must be sufficient to aid in the forming of a film on the metal. The amount of polymer present should be that amount which will be effective under the particular operating conditions of the treating process, so as to improve the corrosion resistant abilities and binding properties of the coating. In one embodiment of the invention, the concentration of the first polymer is in the range of 0.03 to 0.9 grams/liter, and the concentration of the second polymer is in the range of from 0.01 to 1.2 grams per liter.

In one embodiment, suitable for use on aluminum extrusions (among other applications), the composition includes about 0.27 grams/liter of PMVEMA, about 0.15 grams/liter of PVA, about 0.4 grams/liter of organo-functional silane, and about 0.6 grams/liter of a compound of a group IV-B element. These concentrations correspond to an approximately 0.9:1 ratio of equivalents of carboxylic functional groups to hydroxyl functional groups. Typically, compositions according to the invention may be sprayed onto aluminum substrates as aqueous solutions containing about 1-2% on a nonvolatiles basis, although other application means may be used.

In another embodiment, suitable for use in coil coating applications (among other applications), the composition includes about 14.6 grams/liter of PMVEMA, about 7.06 grams/liter of polyvinyl alcohol, about 19.6 grams/liter of organo-functional silane, and about 29 grams/liter of a compound of a group IV-B element. These concentrations correspond to about a 1.0:1 ratio of equivalents of carboxylic functional groups to hydroxyl functional groups. These concentrations correspond to a typical undiluted formulation, such as might be applied by use of metering equipment. Alternatively, such a formulation may be made using the same proportions of ingredients relative to each other, but with more or less water. For example, a more dilute composition may typically be used in cases where metering equipment capable of laying down sufficiently low amounts of coating is not available, and other means of application known in the art are to be used.

The overall concentration of ingredients used for a particular application depend on a number of process parameters, such as line speed and temperature. In addition, appropriate concentration ranges of the various components is dependent on their solubilities. At concentrations too low, there is insufficient coating to cover the metal surface. Above the solubility limits, the polymers begin to come out of the solution. Formulating compositions according to the invention in light of these constraints is well within the ability of the person of normal skill in the art.

In preparing compositions according to the invention, the order of addition of the constituents is not critical. In a typical preparation, the polymer blend is first made by dissolving the first and second polymers in water. Then, the silane is added and the composition is mixed until the silane is hydrolyzed and soluble.

Treatment of metal surfaces according to the invention typically comprises:
1) cleaning, preferably with a first bath which is an alkaline cleaning solution, the metal surface to form a cleaned metal surface;
2) rinsing the cleaned metal surface with water to form a rinsed metal surface; and
3) contacting the metal surface with a composition comprising water, an organo-functional silane, a compound of a group IV-B element, and a polymer blend having a plurality of carboxylic functional groups and a plurality of hydroxyl groups; this step is also referred to as pretreating the metal surface and the composition may be a bath or spray or other form.

Contacting of the metal surface may be performed by any known coating technique, including for example spraying, immersing, roll coating, or flow coating. Optionally, after step 3), the metal surface is dried and then a decorative coating (e.g. painting) is applied, without rinsing between these steps. Thus, the pretreatment is a “dried-in-place” pretreatment.

The cleaning step removes oil and other contaminants from the surface of the metal, and is typically effected by immersing the metal surface in a bath of an alkaline cleaning solution to form a cleaned metal surface. The alkaline cleaning solution may be an aqueous solution of an alkaline cleaning agent. Some exemplary alkaline cleaning agents which can be used according to the present invention include sodium hydroxide and potassium hydroxide. Alternatively, the cleaning step may be carried out by an acidic composition. Other means of cleaning may also be used in addition to, or instead of, alkaline cleaning baths. In some cases, cleaning may not be required at all, and this step may be omitted.

Preferably, the bath temperature during this cleaning step is between about 140° F. and about 180° F., more preferably between about 150° F. and about 170° F., and most preferably about 160° F., although the temperature can vary over a wide range depending on concentration and pH. Furthermore, the bath pH is preferably about 9 to about 12, more preferably from about 10 to about 11, and most preferably about 10.5. A cleaning bath of either sodium or potassium hydroxide at a pH of 10.5 has been found to be particularly effective when applied at a temperature of 160° F. Depending on the exact cleaning solution used, and the nature of surface contaminants to be removed from the metal, the contact time of the metal with the bath typically varies between several seconds and 30 minutes.

A cleaning bath is typically an aqueous solution of a cleaning agent and, optionally, at least one surfactant and at least one builder, which functions as a source of alkali and as a dispersant. Exemplary builders are soda ash or a tripolyphosphate. Similarly, a wide variety of surfactants may be used in the cleaning bath, such as the surfactants disclosed in U.S. Pat. No. 4,370,173 to Dollman. A sequestrant, such as sodium gluconate, may also be included to soften the water by binding calcium and magnesium. If the metal surface is heavily soiled, a detergent may be included in the cleaning bath.

A metal surface which has been contacted by an alkaline cleaning solution is referred to herein as a “cleaned metal surface.” It is cleaned in the sense it has been exposed to the alkaline cleaning solution. It is not completely free of contaminants, however, inasmuch as vestiges of the bath and other impurities may remain. Only after it is rinsed with water can it be viewed as fully cleaned and ready to make contact with a pretreatment composition (i.e., substantially all of the impurities are, by that point, removed).

The rinsing step is a conventional water rinsing step, preferably using deionized water, to remove any excess cleaner or detergent left on the metal surface from the cleaning step. The use of deionized water avoids the introduction of any deleterious ions, such as chloride ions, into the system.

After the metal surface is rinsed, it is treated with an aqueous composition of the sort described above according to the invention. The coating process can be effected by employing any of the coating techniques known in the art. Contact can be effected by spray, immersion or flow coating techniques. The amount of coating should be sufficient to leave from about 3.0 to 40.0 milligrams of the dried coating per each square foot of dried metal surface. By using a solution of higher concentration, it is possible to leave this amount of the dried coating with less solution.

As mentioned above, one well-known coating technique is reverse roll coating, whereby a sheet of metal is pulled between counter-rotating cylinders, which are rotating against the direction of travel of the sheet being unrolled. The solution is rolled down along these cylinders until it contacts the metal. As the sheet metal is passed between the cylinders in a direction against the direction of rotation of the cylinders, some wiping force is applied to the metal. Another conventional method is known as the quick-dip method, whereby sheet metal is dipped into a batch containing the coating composition and is subsequently passed between two rolls to remove the excess. As will be appreciated by one of normal skill in the art, the concentration, temperature, and pH of the bath are interrelated. Preferably, the bath temperature during this contacting step is about 70° F. to about 150° F., although the temperature can vary over a wide range depending on concentration and pH. The bath pH depends on the particular pretreatment composition used.

After pretreatment, the metal is preferably then dried (e.g., by blown air or by an oven). The temperatures for the drying operation may range from about 60° F. to about 500° F. The length of the drying step will depend upon the temperature utilized. In addition, air may be blown over the metal to enhance the evaporation.

Then, a decorative coating may be applied to the dried metal surface. Typical non-limiting examples of decorative coatings include paints and lacquers, such as an acrylic paint sold by PPG of Ohio under the tradename Duracron™ 1000, as noted above. Typically, no rinsing is performed after contacting the rinsed metal surface with the treatment composition and application of the decorative coating. In this way, the generation of waste is minimized. The dried-in-place composition of the present invention serves to adhere the paint or lacquer to the metal and to minimize corrosion.

The methods and compositions of the present invention can be applied in a wide variety of applications. These applications include, as non-limiting examples, extrusion applications and coil coating.

In sum, the present invention provides environmentally friendly compositions and processes for treating metal, while still maintaining excellent paint adhesion and corrosion resistance. More particularly, the present invention avoids the use of chromium, and its associated health hazards and disposal problems.

### EXAMPLES

The following examples are included to more clearly demonstrate the overall nature of the present invention. These examples are exemplary, not restrictive, of the present invention. Examples 1-4 illustrate the improved results obtained by employing aqueous compositions of is this invention.

### Example 1

Aluminum coil stock of 3003 alloy that had been back annealed was supplied by Ormet Aluminum in Jackson, Tenn. This particular alloy is very sensitive to this particular application and is representative of the stock coated by Ormet with the Duracron™ 1000 acrylic paint, sold by PPG. Silwet® A1100 aminopropyltriethoxysilane may be obtained from Crompton Corporation of Greenwich, Conn. A series of Hydrosil® organo-functional silanes, detailed below, is available from Degussa A G of Dusseldorf, Germany. E-CLPS® 2101 is a pretreatment composition comprising PVA, PMVEMA, and fluotitanic acid, sold by Bulk Chemicals, Incorporated of Reading, Pa.

The panels cut from this stock were 4″×12″ and were cleaned in Bulk Kleen® 969 MO, an alkaline coil cleaner, by spray power washing at a 3% by volume concentration and at 130 ° F. temperature for 30 seconds. The panels were then water rinsed and dried by a hot air drier. The panels were cooled to room temperature, to which were applied the following compositions by direct roll application to provide in all cases about 15 mg/ft² of composition on a nonvolatiles basis:
1. E-CLPS® 2101;
2. 100 grams E-CLPS® 2101+1 gram Silwet® A1100;
3. 100 grams E-CLPS® 2101+1 gram Hydrosil® 2929 epoxy silane;
4. 100 grams E-CLPS® 2101+1 gram Hydrosil® 2926 epoxy silane;
5. 100 grams E-CLPS® 2101+1 gram Hydrosil® 2909 aminoalkyl silane;
6. 100 grams E-CLPS® 2101+1 gram Hydrosil® 2759 epoxyglycol silane; and
7. 100 grams E-CLPS® 2101+1 gram Hydrosil® 2907 amino vinyl silane.

These panels were tested to determine the level of titanium by use of the PortaSpec® X-ray Fluorescence Spectrometer. This was to assure that similar levels of material were applied. The results indicated that the panels had similar levels of titanium (about 1.5 mg/ft²) and thus similar levels of coating. These panels were then painted Duracron® 1000 acrylic paint. Panels 2 and 6 passed the T-bend adhesion and the Post Opening test. The panels exhibited no delamination at the 0 T-bend or at the impact, except for the panel made with the formulation containing E-CLPS® 2101, which contained no silane.

### Example 2

This example was carried out to determine if the effect is due purely to the presence of the silane compound. Ormet metal was processed as described in Example 1. The following compositions were used to treat the cleaned panels by direct application roll coat:
1. 100 grams E-CLPS® 2101;
2. 100 grams E-CLPS® 2101+1.0 gram Silwet® A-1100;
3. 100 grams E-CLPS® 2101+2.0 grams Silwet® A-1100; and
4. 100 grams E-CLPS® 2101+3.0 grams Silwet® A-1100.

These panels were then coated and baked with the same PPG acrylic paint used in Example 1 and Post Opening tested with the following results:
1. cracks on the 0 T-bend, delaminates on impact dimple;
2. cracks on the 0 T-bend, no loss on impact dimple;
3. cracks on 0 T-bend, no loss on impact dimple; and
4. delaminates on 0 T-bend, delaminates on dimple.

The results show that there is an optimum range for the amount of silane used relative to E-CLPS®, in terms of the effectiveness of the metal treatment.

### Example 3

This testing was carried out to determine the effectiveness of silane-containing compositions and methods of the invention as an aluminum extrusion pretreatment. Testing was performed against Bulk Chemicals' standard (non-silane) E-CLPS® composition and process. Bulk Chemicals' Bulk Kleen® 749 cleaner, comprising potassium hydroxide, gluconic acid, and tetrasodium ethylenediaminetetraacetate was employed as an aqueous solution at 1% (vol/vol) concentration. The following process steps were employed to clean and pretreat aged aluminum extrusion bars:
1. clean with Bulk Kleen® 749 at 130° F., 30 seconds spray;
2. rinse with fresh tap water;
3. clean with hydrofluoric acid, tap water adjusted to pH=3.9, 25 seconds spray;
4. rinse; and
5. treat with the composition to be tested at 0.5% by volume, 15 seconds spray.

The aged extrusion bars are significant in that aged and oxidized extrusions are often encountered in the extrusion industry. These aged oxidized extrusions can be a significant problem as many companies do not extrude aluminum but rather buy and store extrusions for future processing. These extrusions have often aged and oxidized significantly before being treated. The processing of old and oxidized extrusions can be a problem if there is insufficient etching of the extrusion surface in the alkaline cleaning stage. The result will be an incompletely treated surface that will show poor paint adhesion characteristics. This particular situation is exacerbated when bronze extrusion paint is applied since its characteristics are not as good as the standard white extrusion paint systems.

The extrusion panels produced above were coated with polyester extrusion paints, both standard white and bronze, by dip application and were subsequently baked in a 350° F. oven for 13 minutes. The coated and baked extrusions were then permitted to cool to room temperature and tested. Testing of the prepared extrusion panels are tabulated below. The tests below are well-known in the art and are set forth in U.S. Pat. No. 5,859,106. In particular, the Cross Hatch Adhesion test is described in Example 6 of the '106 patent, under the description “Dry Adhesion Test.” The Impact Adhesion test was performed according to the procedure described under the term “Reverse Impact Crosshatch” in Example 4 of the '106 patent. The 1-Hour Boiling Water test was performed according to the method described in Example 4 of the '106 patent under the name “20-minute boiling water test,” using a 1 -hour boiling time instead of 20 minutes. The 1500 Hour Salt Fog test was performed according to ASTM B117 (Neutral Salt Spray).

White Polyester Paint

| Pretreatment | Cross Hatch Adhesion | Impact Adhesion |
|---|---|---|
| E-CLPS ® 2101 | Good paint adhesion | Pass |
| E-CLPS ® 2101 + | Good paint adhesion | Pass |
| Silwet ® A-1100 | | |
| Pretreatment | 1 Hour Boiling Water | 1500 Hours Salt Fog |
| ECLPS ® 2101 | Pass | Excellent |
| E-CLPS ® 2101 + 2% | Pass | Excellent |
| Silwet ® A-1100 | | |

Bronze Polyester Paint

| Pretreatment | Cross Hatch Adhesion | Impact Adhesion |
|---|---|---|
| E-CLPS ® 2101 | Good paint adhesion | Pass |
| E-CLPS ® 2101 + 2% | Good paint adhesion | Pass |
| Silwe ® t A-1100 | | |
| Pretreatment | 1 Hour Boiling Water | 1500 Hours Salt Fog |
| E-CLPS ® 2101 | Massive Loss (90% Loss) | Fail |
| E-CLPS ® 2101 + 2% | Minimal Loss (15% Loss) | Pass |
| Silwet ® A-1100 | | |

Adhesion was as good with the composition containing organo-functional silane as it was with Bulk's standard product E-CLPS® 2101. However, with the bronze paint, it can be seen that adhesion with the boiling water test was significantly improved, even over a heavily oxidized aluminum surface.

### Example 4

The material was examined for its effectiveness on ferrous metals. In this experiment a series of ferrous based substrates was treated with E-CLPS® 2101, the organo-functional silane-containing material (E-CLPS® 2101+2% Silwet® A-1100), and Bulk NP-250 (a silica/chromium chromate dry-in-place pretreatment, available from Bulk Chemicals, Inc.). Substrates were cold rolled steel, electro-galvanized steel, and hot dipped galvanized steel. In this experiment the following process sequence was use for panel preparation:
1. clean with Bulk Kleen® 835, 3% (vol/vol), 140° F., 30 seconds clean for the cold rolled steel and 90 seconds for the electro-galvanized steel;
2. rinse with tap water;
3. treat by roll coat application of the pretreatment; and
4. hot air dry.

Bulk Kleen® 835 contains potassium hydroxide, potassium silicate, sodium tri polyphosphate, gluconic acid, and a surfactant.

The prepared panels were then coated with acrylic and polyester paints. T-bend adhesion test were then performed with the following results:

T-bend Results for Cold Rolled Steel

| Pretreatment | Acrylic Paint | Polyester Paint |
|---|---|---|
| E-CLPS ® 2101 | 3T very slight pick off | 0T |
| E-CLPS ® 2101 + 2% | 2T | 0T |
| Silwet ® A-1100 | | |
| NP-250 | 3T | 0T |

T-bend Results for Electro-Galvanized Steel

| Pretreatment | Acrylic Paint | Polyester Paint |
|---|---|---|
| E-CLPS ® 2101 | 4T slight pick off | 0T |
| E-CLPS ® 2101 + 2% | 3T | 0T |
| Silwet ® A-1100 | | |
| NP-250 | 4T slight pick off | 0T |

T-bend Results for Hot Dipped Galvanized Steel

| Pretreatment | Acrylic Paint | Polyester Paint |
|---|---|---|
| E-CLPS ® 2101 | 4T slight pick off | 0T |
| E-CLPS ® 2101 + 2% | 4T very slight pick off | 0T |
| Silwet ® A-1100 | | |
| NP-250 | >4T slight pick off | 0T |

The results show that the compositions and methods of the present invention provide improved adhesion over those provided by a standard chromium-free process, while maintaining good corrosion resistance.

Although the invention is illustrated and described herein with reference to specific embodiments, the invention is not intended to be limited to the details shown. Rather, various modifications may be made in the details within the scope and range of equivalents of the claims and without departing from the invention.

1. A composition for treating a metal surface to improve paint adhesion and corrosion resistance, said composition comprising water, an organo-functional silane, a compound of a group IV-B element, and a polymer blend having a plurality of carboxylic functional groups and a plurality of hydroxyl groups.

2. The composition of claim 1, wherein the ratio of equivalents of carboxylic functional groups to hydroxyl groups is between 0.3:1.0 and 3.5:1.0.

3. The composition of claim 1, wherein the weight ratio of silane to polymer blend is between 0.25:1 and 2.0:1.

4. The composition of claim 1, wherein the weight ratio of silane to polymer blend is between 0.5:1 and 1.0:1.

5. The composition of claim 1, wherein said organo-functional silane is selected from the group consisting of an aminopropyltriethoxy silane, a mercapto silane, and an epoxy silane.

6. The composition of claim 1, wherein said polymer blend comprises a first polymer having carboxylic functional groups and a second polymer having hydroxyl groups.

7. The composition of claim 6, wherein said first polymer is selected from the group consisting of polyacrylic acid and polymethylvinylether-co-maleic acid and said second polymer is polyvinyl alcohol.

8. The composition of claim 1, wherein said compound of a group IV-B element is an acid selected from the group consisting of fluozirconic acid, fluotitanic acid, and fluohafnic acid.

9. A composition for treating a metal surface to improve paint adhesion and corrosion resistance, said composition consisting essentially of water, an organo-functional silane, a compound of a group IV-B element, and a polymer blend having a plurality of carboxylic functional groups and a plurality of hydroxyl groups.

10. The composition of claim 9, wherein the ratio of equivalents of carboxylic functional groups to hydroxyl groups is between 0.3:1.0 and 3.5:1.0.

11. The composition of claim 9, wherein the weight ratio of silane to polymer blend is between 0.25:1 and 2.0:1.

12. The composition of claim 9, wherein the weight ratio of silane to polymer blend is between 0.5:1 and 1.0:1.

13. The composition of claim 9, wherein said organo-functional silane is selected from the group consisting of an aminopropyltriethoxy silane, a mercapto silane, and an epoxy silane.

14. The composition of claim 9, wherein said polymer blend comprises a first polymer having carboxylic functional groups and a second polymer having hydroxyl groups.

15. The composition of claim 14, wherein said first polymer is selected from the group consisting of polyacrylic acid and polymethylvinylether-co-maleic acid and said second polymer is polyvinyl alcohol.

16. The composition of claim 9, wherein said compound of a group IV-B element is an acid selected from the group consisting of fluozirconic acid, fluotitanic acid, and fluohafnic acid.

17. A method for treating a metal surface to improve paint adhesion and corrosion resistance comprising contacting the metal surface with a composition comprising water, an organo-functional silane, a compound of a group IV-B element, and a polymer blend having a plurality of carboxylic functional groups and a plurality of hydroxyl groups.

18. The method of claim 17, wherein the ratio of equivalents of carboxylic functional groups to hydroxyl groups is between 0.3:1.0 and 3.5:1.0.

19. The method of claim 17, wherein the weight ratio of silane to polymer blend is between 0.25:1 and 2.0:1.

20. The method of claim 17, wherein the weight ratio of silane to polymer blend is between 0.5:1 and 1.0:1.

21. The method of claim 19, wherein the organo-functional silane is selected from the group consisting of an aminopropyltriethoxy silane, a mercapto silane, and an epoxy silane.

22. The method of claim 17, wherein said polymer blend comprises a first polymer having carboxylic functional groups and a second polymer having hydroxyl groups.

23. The method of claim 22, wherein said first polymer is selected from the group consisting of polyacrylic acid and polymethylvinylether-co-maleic acid and said second polymer is polyvinyl alcohol.

24. The method of claim 9, wherein said compound of a group IV-B element is an acid selected from the group consisting of fluozirconic acid, fluotitanic acid, and fluohafnic acid.

25. The method of claim 17, wherein the metal surface is an aluminum surface.

26. A method for treating a metal surface to improve paint adhesion and corrosion resistance comprising the steps of:
cleaning the metal surface to form a cleaned metal;
rinsing the cleaned metal with water to form a rinsed metal; and
contacting the rinsed metal with a composition comprising water, an organo-functional silane, a compound of a group IV-B element, and a polymer blend having a plurality of carboxylic functional groups and a plurality of hydroxyl groups.

27. The method of claim 26 further comprising, after the contacting step, the steps of:
drying the metal surface; and
then painting the metal surface with an acrylic paint.

28. The method of claim 27, wherein the acrylic paint comprises titanium dioxide, normal butyl alcohol, xylene, heavy aromatic solvent naphtha, diacetone alcohol, a ketone mixture, light aromatic solvent naphtha, one or more film formers, and one or more resins.

29. The method of claim 26, wherein the cleaning step comprises contacting the metal surface with an alkaline cleaner.

30. The method of claim 29, wherein the alkaline cleaner comprises potassium hydroxide, gluconic acid, and either tetrasodium ethylenediaminetetraacetate or a combination of potassium silicate and sodium tri polyphosphate.
